(19) United States
(12) Patent Application Publication
(10) Pub. No.: US 2012/0303556 A1
(43) Pub. Date: Nov. 29, 2012

(54) COMPARISON OF MODELING AND INFERENCE METHODS AT MULTIPLE SPATIAL RESOLUTIONS

(75) Inventors: Jyh-Han Lin, Mercer Island, WA (US); Gursharan Singh Sidhu, Seattle, WA (US); Sindhura Bandhakavi, Redmond, WA (US); Weili Liu, Redmond, WA (US)

(73) Assignee: Microsoft Corporation, Redmond, WA (US)

(21) Appl. No.: 13/117,169

(22) Filed: May 27, 2011

(51) Int. Cl. G06F 15/18

(52) U.S. Cl. 706/12

(57) ABSTRACT

Embodiments provide a position service experimentation system to enable comparison of modeling and inference methods as well as characterization of input datasets for correspondence to output analytics. Crowd-sourced positioned observations are divided into a training dataset and a test dataset. A beacons model is generated based on the training dataset, while device position estimations are calculated for the test dataset based on the beacons model. The device position estimations are compared to the known position of the computing devices generating the positioned observations to produce accuracy values. The accuracy values are assigned to particular geographic areas based on the position of the observing computing device and aggregated to enable a systematic analysis of the accuracy values based on geographic area and/or positioned observations characteristics.

### BACKGROUND

Some existing positioning services provide position information to requesting computing devices based on crowd-sourced data. In such systems, the requesting computing devices provide a set of observed beacons and the positioning service returns an inferred approximate position of the requesting computing devices based on the set of observed beacons. The accuracy of the approximate position determined by the positioning service, however, is dependent on the quality of the crowd-sourced data, the modeling algorithms that estimate beacon models (e.g., that model beacon data structures), and/or the position inference algorithms that calculate the approximate position of the requesting computing device. The crowd-sourced data may be noisy and unreliable due to differences in the devices providing the crowd-sourced data, the locations of the devices, and conditions under which the crowd-sourced data was obtained by the devices (e.g., signal strength, environment type, etc.). Further, one modeling algorithm or position inference algorithm may perform better than another algorithm on a particular set of crowd-sourced data, or in a particular geographic area. Existing systems fail to provide or enable a systematic analysis of crowd-sourced data quality and of performance of the modeling algorithms and the position inference algorithms.

### SUMMARY

Embodiments of the disclosure compare performance of modeling algorithms and position inference algorithms. Crowd-sourced positioned observations are divided into a training dataset and a test dataset. Each of the crowd-sourced positioned observations includes a set of beacons observed by one of a plurality of computing devices, and an observation position of the computing device. The crowd-sourced positioned observations are assigned to one or more geographic areas based on the observation positions associated with each of the crowd-sourced positioned observations and a position associated with each of the geographic areas. A beacons model is estimated based on the positioned observations in the training dataset. For each of the positioned observations in the test dataset, a device position estimate is determined based on the determined beacons model. The determined device position estimate is compared to the known observation position of the computing device to calculate a positioning accuracy value. An aggregate accuracy value is calculated for each of the areas based on the calculated accuracy values of the positioned observations assigned thereto from the test dataset.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a positioning experimentation framework for analyzing position determination methods using positioned observations divided into a training dataset and a test dataset.

FIG. 2 is an exemplary block diagram illustrating a computing device for analyzing modeling algorithms and position inference algorithms.

FIG. 3 is an exemplary flow chart illustrating operation of the computing device to calculate aggregate accuracy values associated with performance of position determination methods.

FIG. 4 is an exemplary block diagram illustrating a pipeline for performing analytics on position determination methods using datasets derived from positioned observations.

FIG. 5 is an exemplary experiment process flow diagram illustrating comparison of the performance of two experiments using different position determination methods.

FIG. 6 is an exemplary block diagram illustrating an experiment group of three experiments for generating comparative analytics.

FIG. 7 is an exemplary diagram illustrating geographic tiles at three levels of spatial resolution.

Corresponding reference characters indicate corresponding parts throughout the drawings.

### DETAILED DESCRIPTION

Referring to the figures, embodiments of the disclosure provide a systematic positioning service experimentation framework for analyzing the performance of modeling and position inference methods. In some embodiments, the input data is characterized and correlated to output analytics (e.g., accuracy). By assigning the input data to defined geographic areas such as tiles, the output analytics can be analyzed at multiple levels of spatial resolution.

Aspects of the disclosure are operable in an environment in which devices such as mobile computing devices or other observing computing devices 210 observe or detect one or more beacons 212 at approximately the same time (e.g., an observation time value 216) while the device is at a particular location (e.g., an observation position 214). The set of observed beacons 212, the observation position 214, the observation time value 216, and possibly other attributes constitute a positioned observation 102. The mobile computing devices detect or observe the beacons 212, or other cell sites, via one or more radio frequency (RF) sensors associated with the mobile computing devices. Aspects of the disclosure are operable with any beacon 212 supporting any quantity and type of wireless communication modes including cellular division multiple access (CDMA), Global System for Mobile Communication (GSM), wireless fidelity (Wi-Fi), 4G/Wi-Max, and the like. Exemplary beacons 212 include cellular towers (or sectors if directional antennas are employed), base stations, base transceiver stations, base station sites, wireless fidelity (Wi-Fi) access points, satellites, or other wireless access points (WAPs). While aspects of the disclosure may be described with reference to beacons 212 implementing protocols such as the 802.11 family of protocols, embodiments of the disclosure are operable with any beacon 212 for wireless communication.

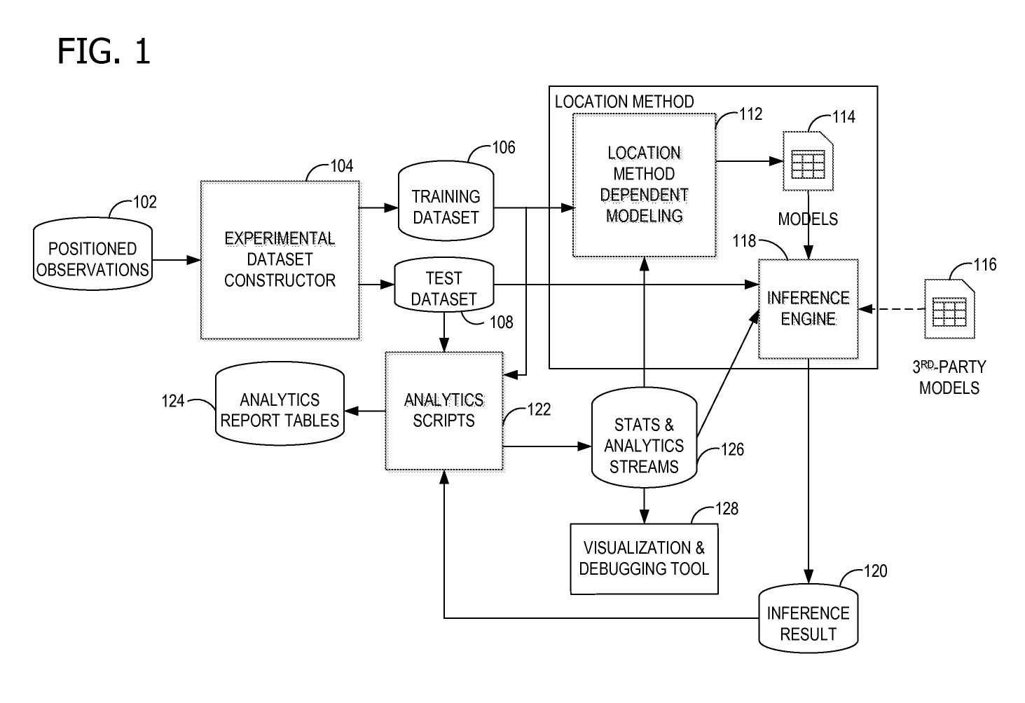

Referring next to FIG. 1, an exemplary block diagram illustrates the position experimentation framework for analyzing position determination methods using positioned observations 102 grouped into a training dataset 106 and a test dataset 108. The training dataset 106 includes training positioned observations, and the test dataset 108 includes test positioned observations. The position experimentation framework includes an experimental dataset constructor 104, which divides positioned observations 102 into the training dataset 106 and the test dataset 108. In some embodiments, the training dataset 106 and the test dataset 108 are mutually exclusive (e.g., no overlap). In other embodiments, at least one position observation 102 is included in both the training dataset 106 and the test dataset 108. Using positioning method-dependent modeling 112 (e.g., a modeling algorithm 228 and a position inference algorithm 230), models 114 are constructed from the training dataset 106. The models 114 include a set of beacons 212 and the positions of each of the beacons 212. An inference engine 118 applies at least one of the position inference algorithms 230 to the test dataset 108 and uses the models 114 to infer position inference results 120 such as device position estimates 224 for the observing computing devices 210. In some embodiments, the inference engine 118 also uses third-party models 116 to produce the position inference results 120. The device position estimates 224 represent inferred positions of the observing computing devices 210 in each of the positioned observations 102 in the test dataset 108. Analytics scripts 122 analyze the inference results 120 in view of the training dataset 106 and the test dataset 108 to produce analytic report tables 124 and statistics and analytics streams 126. The analytics scripts 122, in general, calculate the accuracy of the positioning method, such as an error distance. The statistics and analytics streams are used by visualization and debugging tools 128 and by the inference engine 118.

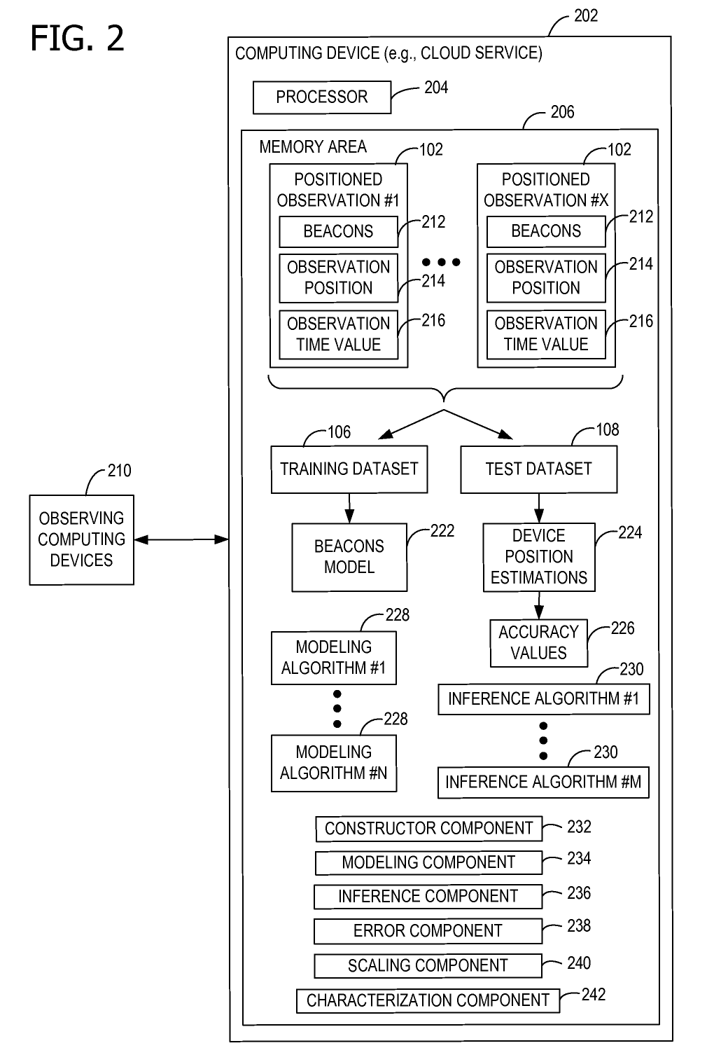

Referring next to FIG. 2, an exemplary block diagram illustrates a computing device 202 for analyzing modeling algorithms 228 and position inference algorithms 230. In some embodiments, the computing device 202 represents a cloud service for implementing aspects of the disclosure. For example, the cloud service may be a position service accessing positioned observations 102 stored in a beacon store. In such embodiments, the computing device 202 is not a single device as illustrated, but rather a collection of a plurality of processing devices and storage areas arranged to implement the cloud service.

In general, the computing device 202 represents any device executing instructions (e.g., as application programs, operating system functionality, or both) to implement the operations and functionality associated with the computing device 202. The computing device 202 may also include a mobile computing device or any other portable device. In some embodiments, the mobile computing device includes a mobile telephone, laptop, tablet, computing pad, netbook, gaming device, and/or portable media player. The computing device 202 may also include less portable devices such as desktop personal computers, kiosks, and tabletop devices. Additionally, the computing device 202 may represent a group of processing units or other computing devices.

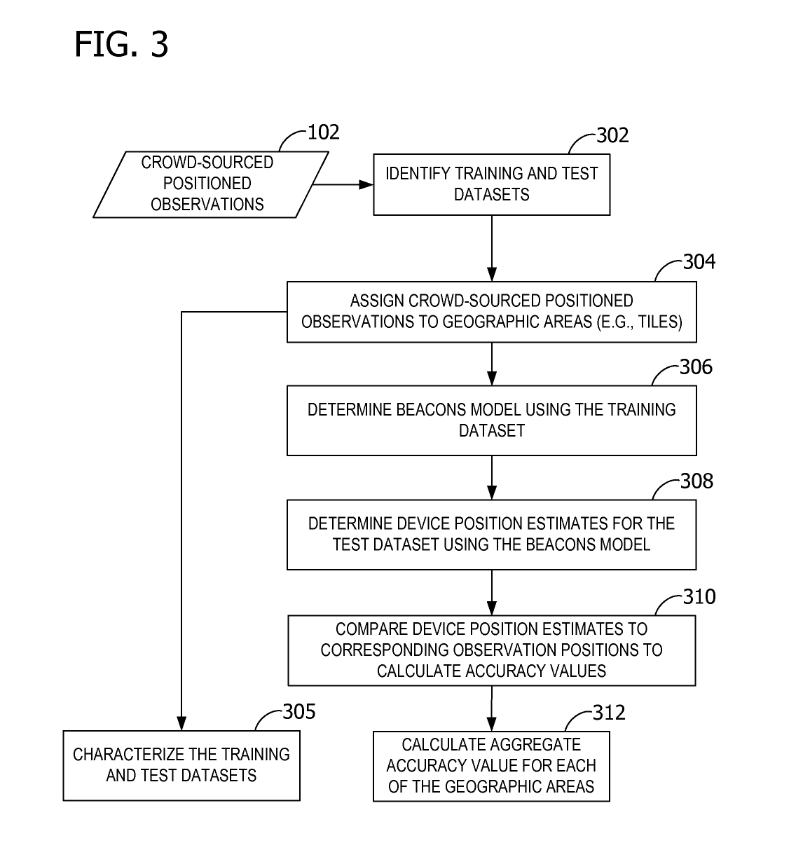

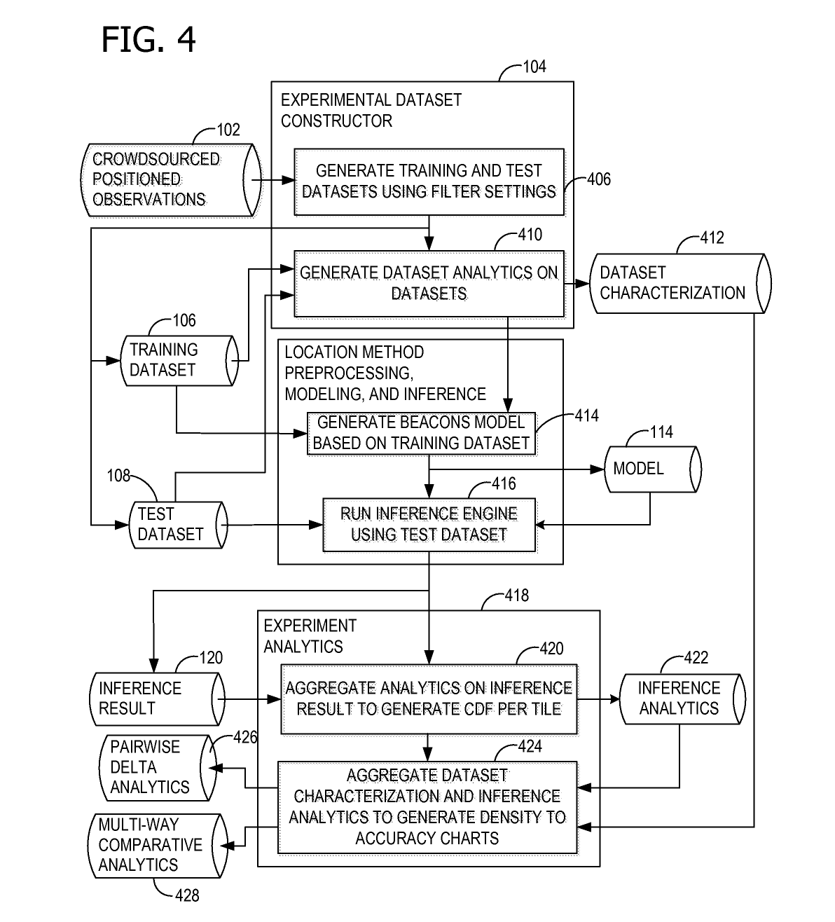

The computing device 202 has at least one processor 204 and a memory area 206. The processor 204 includes any quantity of processing units, and is programmed to execute computer-executable instructions for implementing aspects of the disclosure. The instructions may be performed by the processor 204 or by multiple processors executing within the computing device 202, or performed by a processor external to the computing device 202. In some embodiments, the processor 204 is programmed to execute instructions such as those illustrated in the figures (e.g., FIG. 3 and FIG. 4).

The computing device 202 further has one or more computer readable media such as the memory area 206. The memory area 206 includes any quantity of media associated with or accessible by the computing device 202. The memory area 206 may be internal to the computing device 202 (as shown in FIG. 2), external to the computing device 202 (not shown), or both (not shown). The memory area 206 stores, among other data, one or more positioned observations 102 such as positioned observation #1 through positioned observation #X. In the example of FIG. 2, each of the positioned observations 102 includes a set of one or more beacons 212, an observation position 214, an observation time value 216, and other properties describing the observed beacons 212 and/or the observing computing device 210. An exemplary observation position 214 may include values for a latitude, longitude, and altitude of the observing computing device 210. For example, the observation position 214 of the observing computing device 210 may be determined via a global positioning system (GPS) receiver associated with the observing computing device 210.

The computing device 202 may receive the positioned observations 102 directly from the observing computing devices 210. Alternatively or in addition, the computing device 202 may retrieve or otherwise access one or more of the positioned observations 102 from another storage area such as a beacon store. In such embodiments, the observing computing devices 210 transmit, via a network, the positioned observations 102 to the beacon store for access by the computing device 202 (and possibly other devices as well). The beacon store may be associated with, for example, a positioning service that crowd-sources the positioned observations 102. The network includes any means for communication between the observing computing devices 210 and the beacon store or the computing device 202.

As described herein, aspects of the disclosure operate to divide, separate, construct, assign, or otherwise create the training dataset 106 and the test dataset 108 from the positioned observations 102. The training dataset 106 is used to generate the beacon related data model (e.g., beacons model 222) of the position inference algorithm 230. For some position inference algorithms 230, the model includes beacon position estimates of the beacons 212 therein.

Aspects of the disclosure further calculate, using the beacon models, the estimated positions (e.g., device position estimates 224) of the observing computing devices 210 in the test dataset 108. Each of the device position estimates 224 identifies a calculated position of one of the observing computing devices 210 (e.g., mobile computing devices) in the test dataset 108.

The memory area 206 further stores accuracy values 226 derived from a comparison between the device position estimates 224 and the corresponding observation positions 214, as described herein. The accuracy values 226 represent, for example, an error distance.

The memory area 206 further stores one or more modeling algorithms 228 and one or more position inference algorithms 230. Alternatively or in addition, the modeling algorithms 228 and position inference algorithms 230 are stored remotely from the computing device 202. Collectively, the modeling algorithms 228 and position inference algorithms 230 may be associated with one or more of a plurality of position determination methods, and provided by a positioning service.

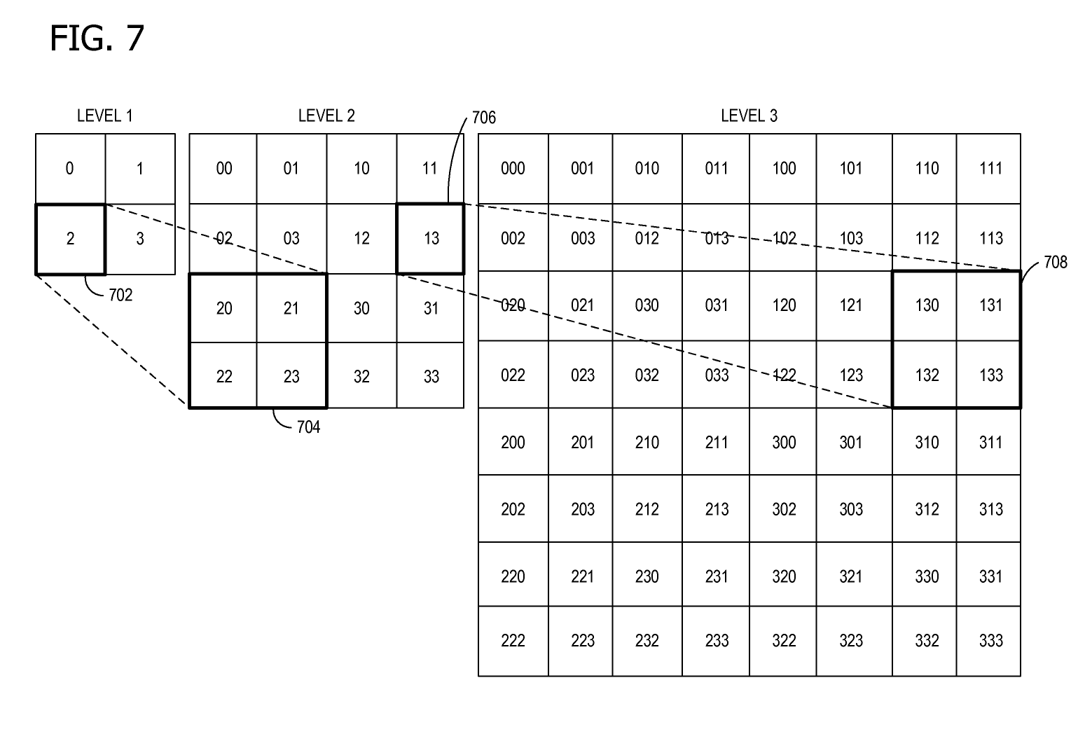

The memory area 206 further stores one or more computer-executable components. Exemplary components include a constructor component 232, a modeling component 234, an inference component 236, an error component 238, a scaling component 240, and a characterization component 242. The constructor component 232, when executed by the processor 204, causes the processor 204 to separate the crowd-sourced positioned observations 102 into the training dataset 106 and the test dataset 108. The constructor component 232 assigns the crowd-sourced positioned observations 102 to one or more geographic tiles or other geographic areas based on the observation positions 214 in each of the crowd-sourced positioned observations 102. FIG. 7 includes an illustration of exemplary geographic tiles. In some embodiments, the crowd-sourced positioned observations 102 may be grouped by beacon 212 to enable searching for positioned observations 102 based on a particular beacon 212 of interest.

The modeling component 234, when executed by the processor 204, causes the processor 204 to determine the beacons model 222 based on the positioned observations in the training dataset 106.

In embodiments that contemplate beacon position estimation, for each beacon 212, the beacon position estimates are calculated based on the observation positions 214 in the training dataset 106 associated with the beacon 212. That is, aspects of the disclosure infer the position of each beacon 212 based on the positioned observations in the training dataset 106 that involve the beacon 212. As a result, in such embodiments, the modeling component 234 generates models 114 including a set of beacons 212 and approximate positions of the beacons 212.

The modeling component 234 implements at least one of the modeling algorithms 228.

The inference component 236, when executed by the processor 204, causes the processor 204 to determine, for each of the positioned observations in the test dataset 108, the device position estimate 224 for the observing computing device 210 based on the beacon model determined by the modeling component 234. The inference component 236 implements the position inference algorithms 230, and is operable with any exemplary algorithm (e.g., refining algorithm) for determining a position of one of the observing computing devices 210 based on the beacons model 222, as known in the art. For each of the positioned observations in the test dataset 108, the inference component 236 further compares the device position estimate 224 for the observing computing device 210 to the known observation position 214 of the observing computing device 210 in the test dataset 108 to calculate the accuracy value 226.

The error component 238, when executed by the processor 204, causes the processor 204 to calculate an aggregate accuracy value for each of the tiles based on the calculated accuracy values 226 of the positioned observations assigned thereto in the test dataset 108. For example, the error component 238 groups the calculated accuracy values 226 of the test dataset 108 per tile, and calculates the aggregate accuracy value for each tile using the grouped accuracy values 226.

The scaling component 240, when executed by the processor 204, causes the processor 204 to adjust a size of the tiles to analyze the accuracy values 226 aggregated by the error component 238. The size corresponds to one of a plurality of levels of spatial resolution. FIG. 7 illustrates varying levels of spatial resolution. As the size of the tiles changes, aspects of the disclosure re-calculate the aggregate accuracy values, and other analytics, for each of the tiles as described herein.

The characterization component 242, when executed by the processor 204, causes the processor 204 to calculate data quality attributes and data density attributes for the crowd-sourced positioned observations 102. Exemplary data quality attributes and exemplary data density attributes are described below with reference to FIG. 4. Further, the error component 238 may perform a trend analysis on the data quality attributes and the data density attributes calculated by the characterization component 242. The trend analysis illustrates how these statistics evolve over time. For example, for a given tile, the trend analysis shows how fast the observation density increases or how the error distance changes over time.

In some embodiments, the characterization component 242 compares the calculated aggregate accuracy values to beacon density in, for example, a scatter plot.

Referring next to FIG. 3, an exemplary flow chart illustrates operation of the computing device 202 (e.g., cloud service) to calculate aggregate accuracy values associated with performance of position determination methods. In some embodiments, the operations illustrated in FIG. 3 are performed by a cloud service such as a position determination service. At 302, the training dataset 106 and the test dataset 108 are identified. For example, the crowd-sourced positioned observations 102 are divided into the training dataset 106 and the test dataset 108. The crowd-sourced positioned observations 102 may be divided based on the observation times associated therewith. For example, the training dataset 106 may include the crowd-sourced positioned observations 102 that are older than two weeks, while the test dataset 108 may include the crowd-sourced positioned observations 102 that are less than two weeks old. Aspects of the disclosure contemplate, however, any criteria for identifying the training dataset 106 and the test dataset 108. For example, the positioned observations 102 may be divided based on one or more of the following: geographic area, type of observing computing device 210, position data quality, mobility of observing computing device 210, received signal strength availability, and scan time difference (e.g., between the ends of Wi-Fi and GPS scans).

Further, in some embodiments, the crowd-sourced positioned observations 102 are pre-processed to eliminate noisy data or other data with errors. For example, the crowd-sourced positioned observations 102 may be validated through data type and range checking and/or filtered to identify positioned observations 102 that have a low mobility indicator.

Each of the crowd-sourced positioned observations 102 has an observing computing device 210 (e.g., a mobile computing device) associated therewith. At 304, the crowd-sourced positioned observations 102 are assigned to one or more geographic areas. The crowd-sourced positioned observations 102 may be assigned based on a correlation between the geographic areas and the observation positions 214 associated with each of the crowd-sourced positioned observations 102.

At 306, the beacons model is determined from the training dataset 106. In embodiments in which beacon position estimation is contemplated, beacon position estimates representing the estimated positions of the beacons 212 are calculated as part of the beacons model 222. The beacon position estimate for each beacon 212 is determined based on the observation positions 214 of the observing computing devices 210 in the positioned observations in the training dataset 106 that include the beacon 212. The beacon position estimate is calculated by executing a selection of at least one of the modeling algorithms 228.

At 308, device position estimates 224 for the observing computing devices 210 associated with the positioned observations in the test dataset 108 are determined. For example, the device position estimate 224 for the observing computing device 210 in one of the positioned observations in the test dataset 108 is determined based on the beacons model 222. The device position estimates 224 are calculated by executing a selection of at least one of the position inference algorithms 230.

At 310, for each of the positioned observations in the test dataset 108, the determined device position estimate 224 is compared to the observation position 214 of the observing computing device 210 associated with the positioned observation. The comparison produces the accuracy value 226. In some embodiments, the accuracy value 226 represents an error distance, a distance between the observation position 214 of the observing computing device 210 and the calculated device position estimate 224 of the observing computing device 210, or any other measure indicating accuracy.

At 312, for each of the geographic areas, the accuracy values 226 associated with the positioned observations assigned to the geographic area from the test dataset 108 are combined to calculate an aggregate accuracy value. For example, a mean, median, cumulative distribution function, trend analysis, or other mathematical function may be applied to the accuracy values 226 for each of the geographic areas to produce the aggregate accuracy value for the geographic area.

In some embodiments, the training dataset 106 and the test dataset 108 are characterized or otherwise analyzed to produce dataset analytics at 305. Exemplary dataset analytics include data quality attributes, data density attributes, and an environment type (e.g., rural, urban, dense urban, suburban, indoor, outdoor, etc.) for each of the geographic areas. Further, the performance of the selected modeling algorithm 228 and the selected position inference algorithm 230 may be analyzed to produce quality analytics. In some embodiments, the dataset analytics are correlated to the quality analytics to enable identification and mapping between qualities of the input data to the resulting performance of the positioning methods.

Referring next to FIG. 4, an exemplary block diagram illustrates a pipeline for performing analytics on position determination methods using datasets derived from positioned observations 102. The experimental dataset constructor 104 takes crowd-sourced positioned observations 102 and generates the training dataset 106 and the test dataset 108 based on, for example, filter settings at 406. Dataset analytics are generated for the training dataset 106 and the test dataset 108 at 410. The dataset analytics are stored as dataset characterizations 412.

Exemplary dataset analytics include characterizations in terms of one or more of the following, at various levels of spatial resolutions: cumulative distribution function, minimum, maximum, average, median, and mode. The dataset analytics include data quality attributes, data density attributes, and environment type. Exemplary data quality attributes include one or more of the following: horizontal estimated position error (HEPE), speed/velocity distribution, heading distribution, and delta time stamp. The HEPE represents the estimated 95% position error (e.g., in meters). The delta time stamp represents the difference (e.g., in milliseconds) between the completion of a Wi-Fi access scan and a GPS position fix. Exemplary data density attributes include one or more of the following: observation density (e.g., the number of observations per square kilometer), beacon density (e.g., the number of beacons 212 per square kilometer), distribution of the number of beacons 212 per scan, and distribution of observations per beacon 212.

Preprocessing, modeling, and inference are performed specific to a particular positioning method. For example, the positioning method includes at least one of the modeling algorithms 228 and at least one of the position inference algorithms 230. Models 114 are generated at 414 based on the training dataset 106. The inference engine 118 uses the models 114 at 416 to process the test dataset 108 and produce inference results 120.

Experiment analytics 418 are next performed. Analytics on the inference results 120 are aggregated at 420 to generate, for example, a cumulative distribution function per geographic tile. The aggregated analytics are stored as inference analytics 422. The inference analytics combine different inference results 120 together and aggregate them by geographic tile. The dataset characterization and inference analytics are aggregated to generate, for example, density to accuracy charts at 424. Further, pairwise delta analytics 426 and multi-way comparative analytics 428 may also be performed. The pairwise delta analytics 426 and the multi-way comparative analytics 428 enable finding a correlation between training data properties and error distance analytics reports. The result of this data may be visually analyzed as a scatter graph or pivot chart. For example, the pairwise delta analytics 426 examine the difference between error distances of two alternative methods versus a data metric such as beacon density. In another example, the multi-way comparative analytics 428 illustrate the relative accuracy of multiple experiments give a particular data quality or density metric. Other analytics are contemplated, such as per beacon analytics.

In some embodiments, the experiment analytics have several levels of granularity. There may be individual inference error distances, intra-tile statistics (e.g., 95% error distance for a given tile), inter-tile analytics (e.g., an accuracy vs. beacon density scatter plot for an experiment), and inter-experiment comparative analytics.

Exemplary intra-tile statistics include one or more of the following: test dataset analytics (e.g., beacon total, beacon density, beacon count per inference request), query success rate, cumulative distribution function (e.g., 25%, 50%, 67%, 90%, and 95%), and other statistics such as minimum, maximum, average, variance, and mode. Exemplary inter-tile analytics are summarized form training data over a plurality of geographic tiles and may include scatter plots illustrating one or more of the following: error vs. observation density, error vs. observed beacon density, error vs. number of access points used in the inference request, and error vs. data density and data quality.

Aspects of the disclosure may further relate dataset analytics to accuracy analytics. In some embodiments, there is a continuous model (e.g., no estimation of beacon position) and a discrete model, although other models are contemplated. In the continuous model, D is a data density function and Q is a data quality function. The function D is a data density function of observation density, beacon density, and the distribution of the number of access points per scan. The function Q is a data quality function of HEPE distribution, speed distribution, delta time stamp distribution, and heading distribution. For a given training dataset 106 and a particular geographic tile, aspects of the disclosure calculate the data density indicator and the data quality indicator using the functions D and Q. When combined with a selected accuracy analytic A such as 95% error distance, aspects of the disclosure operate to create a three-dimensional scatter plot, where each data point in the plot is of the form (X=D, Y=Q, Z=A).

In the discrete model, for a particular training dataset 106, aspects of the disclosure classify each geographic tile that covers an area of the training dataset 106 as (D, Q), where values for D and Q are selected from a discrete set of values (e.g., low, medium, and high). As crowd sourced data grows in volume and improves in quality, more tiles are expected to move from (D=low, Q=low) to (D=high, Q=high).

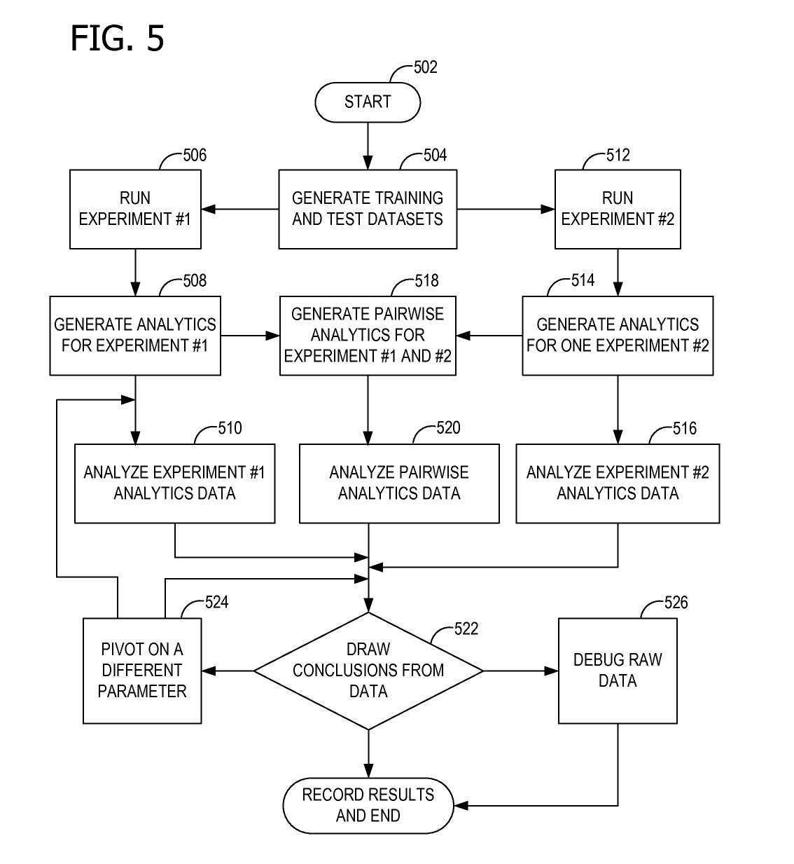

Referring next to FIG. 5, an exemplary experiment process flow diagram illustrates comparison of the performance of two experiments using different position determination methods. The process begins at 502. The training dataset 106 and the test dataset 108 are generated at 504 from the crowd-sourced positioned observations 102. At 506, a first experiment is conducted using a particular positioning method (e.g., using at least one of the modeling algorithms 228 and at least one of the position inference algorithms 230 on a particular training dataset 106 and test dataset 108). Performance analytics are generated for the first experiment at 508, as described herein, and then analyzed at 510. For example, an error distance graph per tile may be created.

At 512, a second experiment is conducted using another positioning method (e.g., different modeling algorithm 228 and/or different position inference algorithm 230 from the first experiment). Performance analytics are generated for the second experiment at 514, as described herein, and then analyzed at 516. Pair-wise analytics are generated for the first and second experiments at 518, and then analyzed at 520. For example, an error distance difference per tile may be created for each of the positioning methods to enable identification of the positioning method providing the better accuracy (e.g., smaller error distance).

At 522, the analyzed analytics data may be reviewed to draw conclusions such as whether a correlation can be seen between any of the characteristics of the training dataset 106 and error distance, whether one positioning method performs better than another for a particular combination of data quality and data density, and the like. If anomalies are detected (e.g., two tiles with similar observation density show varied error distance), the raw positioned observation data may be debugged at 526. Further, the experiments may be re-run after pivoting on a different parameter at 524. For example, if there is no correlation between observation density and error distance, the experiments may be re-run to determine whether there is a correlation between HEPE and error distance.

In some embodiments, the operations illustrated in FIG. 5 may generally be described as follows. In a first experiment, a first one of a plurality of the modeling algorithms 228 is selected and executed with the training dataset 106 as input. This results in the creation of the beacons model 222 based on the training dataset 106. A first one of a plurality of position inference algorithms 230 is selected and executed with the test dataset 108 and the beacons model 222 as input. This results in creation of device position estimates 224 for the observing computing devices 210. The device position estimates 224 are compared to the observation positions 214 of the observing computing devices 210 to calculate accuracy values 226. The accuracy values 226 are assigned to the geographic areas based on the observation position 214 of the corresponding positioned observations in the test dataset 108. Aggregate accuracy values are created by combining the accuracy values 226 from each of the geographic areas.

In a second experiment, the beacons model 222 is recalculated using a second selected modeling algorithm 228 and the device position estimates 224 are recalculated using a second selected position inference algorithm 230. The aggregate accuracy values are re-calculated for each of the geographic areas to enable a comparison of the selected modeling algorithms 228 and the selected position inference algorithms 230 between the first experiment and the second experiment.

In some embodiments, the computing selects the first or second modeling algorithms 228 and/or the first or second position inference algorithms 230 as the better-performing algorithm based on a comparison between the aggregated accuracy values of the first experiment and the second experiment.

In some embodiments, a size of one or more of the geographic areas may be adjusted. The aggregate accuracy value, or other quality analytics, is calculated for each of the re-sized geographic areas by re-combining the corresponding accuracy values 226.

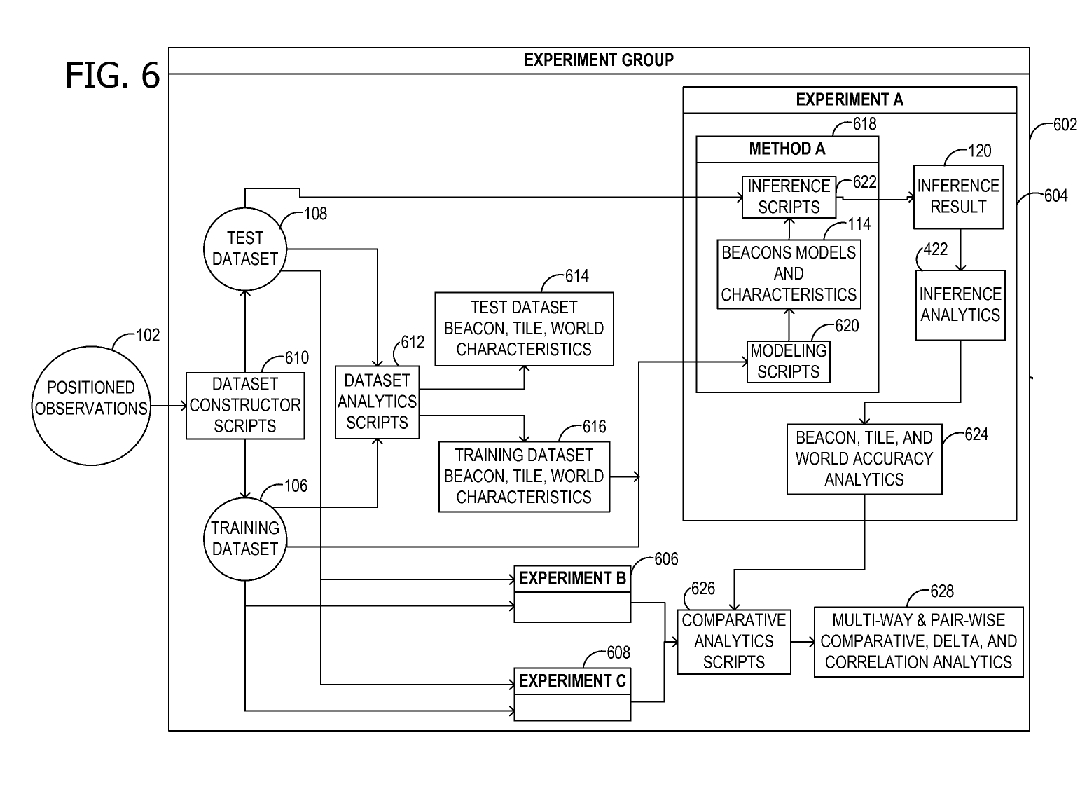

Referring next to FIG. 6, an exemplary block diagram illustrates an experiment group 602 of three experiments for generating comparative analytics. Each of the Experiment A 604, Experiment B 606, and Experiment C 608 represent the application of a selected modeling algorithm 228 and a selected position inference algorithm 230 to a particular training dataset 106 and test dataset 108. Dataset constructor scripts 610 create the training dataset 106 and the test dataset 108 from the positioned observations 102. Dataset analytic scripts 612 create training dataset characteristics 616 and test dataset characteristics 614 at the beacon, tile, and world (e.g., multiple tiles) levels to characterize the output at multiple levels of spatial resolution. In this way, aspects of the disclosure characterize the input data at multiple levels of spatial resolution.

Experiment A 604 applies a particular positioning method 618. This includes executing modeling scripts 620 to create models 114. Inference scripts 622 apply the models 114 to the test dataset 108 to create the inference results 120. Inference analytics are obtained from the inference results 120 to produce accuracy analytics 624 at the beacon, tile, and world (e.g., multiple tiles) levels.

Experiment B 606 and Experiment C 608 are performed using different positioning methods. Comparative analytic scripts 626 are performed on the accuracy analytics 624 from Experiment A 604 as well as the output from Experiment B 606 and Experiment C 608. Multi-way and pair-wise comparative, delta, and correlation analytics are performed at 628.

Referring next to FIG. 7, an exemplary diagram illustrating geographic tiles at three levels of spatial resolution. The different spatial regions may have very different data density, data quality, and radio frequency propagation environment. In the example of FIG. 7, the three levels of spatial resolution include Level 1, Level 2, and Level 3. Tile 702 in Level 1 corresponds to tiles 704 in Level 2. Tiles 706 in Level 2 correspond to tiles 708 in Level 3. An operator is able to drill down into the tiles to partition the data based on zooming, where the data is averaged within each tile.

### Additional Examples

At least a portion of the functionality of the various elements in FIG. 1, FIG. 2, and FIG. 4 may be performed by other elements in the figures, or an entity (e.g., processor, web service, server, application program, computing device, etc.) not shown in the figures.

In some embodiments, the operations illustrated in FIG. 3 and FIG. 5 may be implemented as software instructions encoded on a computer readable medium, in hardware programmed or designed to perform the operations, or both. For example, aspects of the disclosure may be implemented as a system on a chip.

While no personally identifiable information is tracked by aspects of the disclosure, embodiments have been described with reference to data monitored and/or collected from users. In such embodiments, notice is provided to the users of the collection of the data (e.g., via a dialog box or preference setting) and users are given the opportunity to give or deny consent for the monitoring and/or collection. The consent may take the form of opt-in consent or opt-out consent.

### Exemplary Operating Environment

Exemplary computer readable media include flash memory drives, digital versatile discs (DVDs), compact discs (CDs), floppy disks, and tape cassettes. By way of example and not limitation, computer readable media comprise computer readable storage media and communication media. Computer readable storage media store information such as computer readable instructions, data structures, program modules or other data. Computer readable storage media exclude propagated data signals. Communication media typically embody computer readable instructions, data structures, program modules, or other data in a modulated data signal such as a carrier wave or other transport mechanism and include any information delivery media.

Although described in connection with an exemplary computing system environment, embodiments of the invention are operational with numerous other general purpose or special purpose computing system environments or configurations. Examples of well known computing systems, environments, and/or configurations that may be suitable for use with aspects of the invention include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

Aspects of the invention transform a general-purpose computer into a special-purpose computing device when configured to execute the instructions described herein.

The embodiments illustrated and described herein as well as embodiments not specifically described herein but within the scope of aspects of the invention constitute exemplary means for creating models 114 based on the training dataset 106, and exemplary means for comparing the accuracy of different modeling algorithms 228 and different position inference algorithms 230 based on the aggregated accuracy values for the tiles.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A system for comparing performance of modeling algorithms and position inference algorithms, said system comprising:
a memory area associated with a computing device, said memory area storing a plurality of crowd-sourced positioned observations, each of the crowd-sourced positioned observations including a set of beacons observed by one of a plurality of mobile computing devices and an observation position of the mobile computing device, said crowd-sourced positioned observations including training positioned observations and test positioned observations, said memory area further storing a plurality of modeling algorithms and a plurality of position inference algorithms; and
a processor programmed to:
assign the crowd-sourced positioned observations stored in the memory area to one or more geographic tiles based on the observation positions associated with each of the crowd-sourced positioned observations and a position associated with each of the geographic tiles;
determine, using a first one of the plurality of modeling algorithms stored in the memory area, a beacons model based on the training positioned observations;
for each of the test positioned observations,
determine, using a first one of the plurality of position inference algorithms stored in the memory area, a device position estimation based on the determined beacons model, and
compare the determined device position estimation to the observation position of the mobile computing device corresponding to the test positioned observation to calculate an accuracy value;
calculate an aggregate accuracy value for each of the tiles based on the calculated accuracy values of the test positioned observations assigned thereto;
determine the beacons model and the device position estimations using a second one of the plurality of modeling algorithms and/or a second one of the plurality of position inference algorithms; and
re-calculate the aggregate accuracy value for each of the tiles to compare the modeling algorithms and the position inference algorithms.

2. The system of claim 1, wherein the processor is further programmed to:
adjust a size of one or more of the tiles; and
calculate an aggregate accuracy value for each of the adjusted tiles.

3. The system of claim 1, wherein the processor is further programmed to compare the calculated aggregate accuracy values with the re-calculated aggregate accuracy values.

4. The system of claim 3, wherein the processor is further programmed to select the first one of the position inference algorithms or the second one of the position inference algorithms based on the comparison between the calculated aggregate accuracy values and the re-calculated aggregate accuracy values.

5. The system of claim 3, wherein the processor is further programmed to select the first one of the modeling algorithms or the second one of the modeling algorithms based on the comparison between the calculated aggregate accuracy values and the re-calculated aggregate accuracy values.

6. The system of claim 1, further comprising means for creating models based on the training positioned observations.

7. The system of claim 1, further comprising means for comparing the accuracy of different modeling algorithms and different position inference algorithms based on the aggregated accuracy values for the tiles.

8. A method comprising:
dividing crowd-sourced positioned observations into a training dataset and a test dataset, each of the crowd-sourced positioned observations including a set of beacons observed by one of a plurality of computing devices and an observation position of the computing device;
assigning the crowd-sourced positioned observations to one or more geographic areas based on the observation positions associated with each of the crowd-sourced positioned observations and a position associated with each of the geographic areas;
determining a beacons model using the positioned observations in the training dataset;
for each of the positioned observations in the test dataset,
determining a device position estimation based on the determined beacons model; and
comparing the determined device position estimation to the observation position of the computing device corresponding to the positioned observation in the test dataset to calculate an accuracy value; and
calculating an aggregate accuracy value for each of the areas based on the calculated accuracy values of the positioned observations assigned thereto.

9. The method of claim 8, wherein dividing the crowd-sourced positioned observations comprises dividing the crowd-sourced positioned observations based on observation time values associated with the crowd-sourced positioned observations.

10. The method of claim 8, further comprising pre-processing the crowd-sourced positioned observations to eliminate noisy data.

11. The method of claim 8, wherein comparing the determined device position estimation comprises calculating an error distance.

12. The method of claim 8, further comprising selecting a modeling algorithm, and wherein determining the beacons model comprises executing the selected modeling algorithm to determine the beacons model based on the training dataset.

13. The method of claim 8, further comprising selecting a position inference algorithm, and wherein determining the device position estimation comprises executing the selected position inference algorithm based on the determined beacons model.

14. The method of claim 8, further comprising calculating a cumulative distribution function of the calculated aggregate accuracy value.

15. The method of claim 8, further comprising characterizing one or more of the following for the training dataset and the test dataset: data quality attributes, data density attributes, and environment type.

16. The method of claim 8, further comprising:
calculating dataset characterizations based on crowd-sourced positioned observations;
calculating quality characterizations based on the calculated aggregate accuracy values; and
relating the calculated dataset characterizations to the calculated quality characterizations.

17. One or more computer storage media embodying computer-executable components, said components comprising:
a constructor component that when executed causes at least one processor to separate crowd-sourced positioned observations into a training dataset and a test dataset, each of the crowd-sourced positioned observations including a set of beacons observed by one of a plurality of computing devices and an observation position of the computing device, said constructor component assigning the crowd-sourced positioned observations to one or more geographic tiles based on the observation positions associated with each of the crowd-sourced positioned observations and a position associated with each of the geographic tiles;
a modeling component that when executed causes at least one processor to determine a beacons model based on the training dataset based on the positioned observations in the training dataset;
an inference component that when executed causes at least one processor to determine, for each of the positioned observations in the test dataset, a device position estimation based on the beacons model determined by the modeling component and to compare, for each of the positioned observations in the test dataset, the device position estimation determined by the modeling component to the observation position of the computing device corresponding to the positioned observation in the test dataset to calculate an accuracy value;
an error component that when executed causes at least one processor to calculate an aggregate accuracy value for each of the tiles based on the calculated accuracy values of the positioned observations assigned thereto; and
a scaling component that when executed causes at least one processor to adjust a size of the tiles to analyze the accuracy values aggregated by the error component, said size corresponding to one of a plurality of levels of spatial resolution.

18. The computer storage media of claim 17, further comprising a characterization component that when executed causes at least one processor to calculate data quality attributes and data density attributes for the crowd-sourced positioned observations.

19. The computer storage media of claim 18, wherein the characterization component further compares the calculated aggregate accuracy value to beacon density.

20. The computer storage media of claim 18, wherein the error component further performs a trend analysis of the data quality attributes and the data density attributes calculated by the characterization component.
